(19) United States
(12) Patent Application Publication
(10) Pub. No.: US 2013/0311275 A1
(43) Pub. Date: Nov. 21, 2013

(54) Electronic display signs having primary display and second display

(71) Applicants: Llavanya Fernando, San Jose, CA (US); Schayne Jallow, San Jose, CA (US); Sankalpa Gamwarige, Colombo (LK); Ushan Karunathilaka, Colombo (LK); Warnakulasooriya Manjulal Waas, Colombo (LK)

(72) Inventors: Llavanya Fernando, San Jose, CA (US); Schayne Jallow, San Jose, CA (US); Sankalpa Gamwarige, Colombo (LK); Ushan Karunathilaka, Colombo (LK); Warnakulasooriya Manjulal Waas, Colombo (LK)

(73) Assignee: CHIRON DESIGNS LLC

(21) Appl. No.: 13/589,734

(22) Filed: Aug. 20, 2012

Related U.S. Application Data
(63) Continuation-in-part of application No. 13/476,172, filed on May 21, 2012, now abandoned.

(51) Int. Cl. G06Q 30/02

(52) U.S. Cl. CPC G06Q 30/0251
USPC 705/14.49

(57) ABSTRACT

An electronic sign includes a bi-stable display portion to display primary content such as price, type of offer, etc. and another secondary display portion to display secondary content such as enterprise name, logo, eye-catching message, etc. Enterprises are enabled to adhere to their organization's color theme while conveying secondary information. Secondary content may be fixed content or may be selected from a predefined set of content. The presently described electronic sign uses a passive medium to display secondary content along with a bi-stable display for displaying primary content, resulting in an effective, low cost solution.

### FIELD OF THE INVENTION

The present invention relates to electronic display signs.

### BACKGROUND OF THE INVENTION

Present day retailers are moving paper based signage systems to electronic signage systems to display prices, promotional data, etc. from a remote location. Known electronic signage appliances are ultra low power devices equipped with a bi-stable display technology which can only support two colors. Generally the electronic display is used to display primary promotional content. Such electronic signage systems use a bi-stable display to display promotional messages, offers and prices because the bi-stable display consumes no power to retain the content and has the appearance of paper to end user.

Existing paper based signs have a distinctive appearance created by using an organization's color theme, format and logos in order to generate greater attraction. This distinctiveness enables the sign to “grab” the observer's attention. Some retailers use a common format of header, footer, etc. for all the retailer's signs to maintain a uniform, distinctive visual impression. Even the display content such as price, offer, and promotion may follow a limited set of formats. However, bi-stable display technology either does not offer a large range of colors to display colorful secondary information, or it is too expensive.

### BRIEF DESCRIPTION OF THE DRAWING FIGURES

The present invention may be further understood from the following description in conjunction with the appended drawing. In the drawing:

FIG. 1A is a diagram illustrating an electronic sign with a secondary display displaying a permanent or infrequently changing message.

FIG. 1B is a diagram illustrating main components of the electronic circuitry of an electronic display sign unit.

FIG. 2 is a diagram illustrating an electronic sign with a secondary display having a holder to insert a message.

FIG. 3 is a diagram illustrating an exemplary electronic sign with a secondary display displaying changeable secondary message.

FIG. 4 is a diagram illustrating an electronic sign like that of FIG. 3 having a changeable secondary message with direction and location identification feature.

FIG. 5 is a diagram illustrating an example of an electronic sign with a secondary display having a scanimation feature.

FIG. 6 is a diagram illustrating an electronic sign with a secondary display having a holder used to insert a partly-transparent placard.

### DETAILED DESCRIPTION

### Summary

An electronic sign includes a bi-stable display portion to display primary content such as price, type of offer, etc. and another secondary display portion to display secondary content such as enterprise name, logo, eye-catching message, etc. Enterprises are enabled to adhere to their organization's color theme while conveying secondary information. Secondary content may be fixed content or may be selected from a predefined set of content. The presently described electronic sign, in one embodiment, uses a passive medium to display secondary content along with a bi-stable display for displaying primary content, resulting in an effective, low cost solution.

In one aspect, an electronic display sign includes an electronic display and a print-based display, wherein a direction that the electronic display faces and a direction that the print-based display faces are the same.

In another aspect, an electronic display sign includes a monochrome electronic display and a color display, wherein a direction that the monochrome electronic display faces and a direction that the color display faces are the same.

### Description

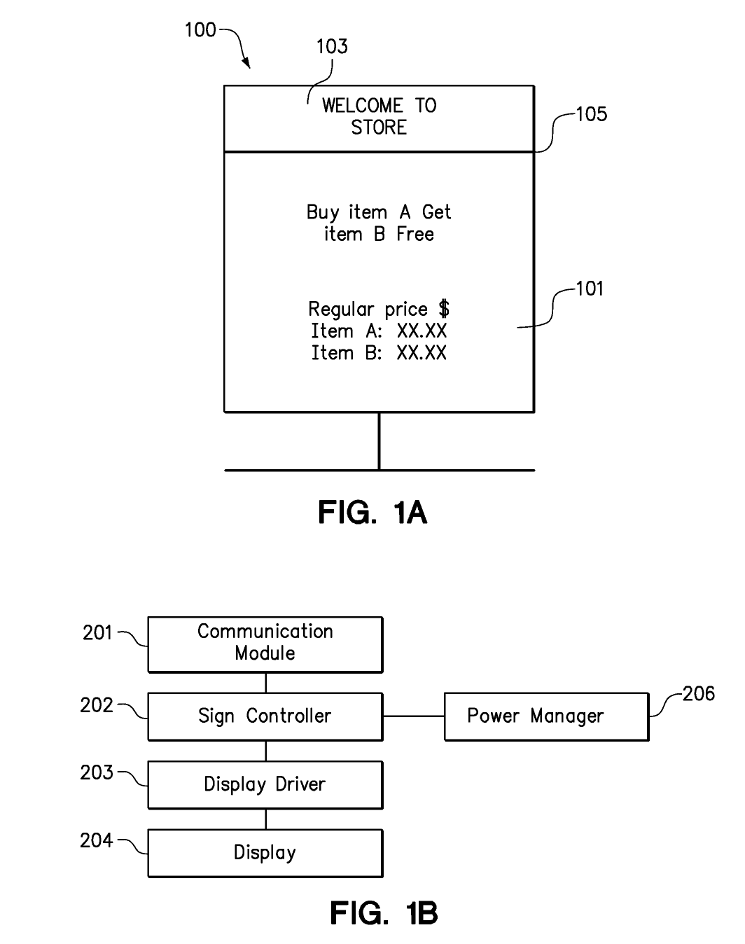

Referring to FIG. 1A, a diagram is shown illustrating an electronic sign 100. The electronic sign 100 includes two display portions to display primary content and secondary content. More particularly, the electronic display has a primary display 101 displaying, for example, promotional content such as item identification, price, etc. The primary display may be, for example, a bi-stable display. A secondary display 103 displays a message which may be a permanent or infrequently changing message. The permanent or infrequently changing message, for example, may identify the store in which the sign is displayed. The permanent or infrequently changing message may be in color and may be consistent with an established visual identity, or look and feel, of that store. The secondary display 103 may be a color electronic display of any of various types, or may be a print-based display. A print-based display is more economical but less flexible than an electronic display. Secondary content may include a sticker which is fixed to a placard bearing the permanent or infrequently changing message, the placard being inserted into a holder of a housing of the electronic sign 100.

Referring to FIG. 6, the placard may be transparent material on which a message can be printed in color, forming a secondary display 603. Then it can be inserted to a place holder in such a way that the transparent placard is placed in front of the electronic sign so as to fully or partially cover the electronic display, i.e., primary display 601. In one embodiment, the transparent placard covers at least a majority of the electronic display. The original message displayed on the electronic display is visible through the transparent placard. A holder for the placard may enable the placard to cover the entire electronic display area enabling a store associate to cover a malfunctioning electronic display by a non-transparent placard.

The primary display 101 and the secondary display 103 may be arranged such that any gap between the two (for example border 105) is slight. Then the observer perceives the two types of displays as a single sign. The secondary display 103 may abut the primary display 101 on any edge or on one or more edges, or may even surround the primary display 101.

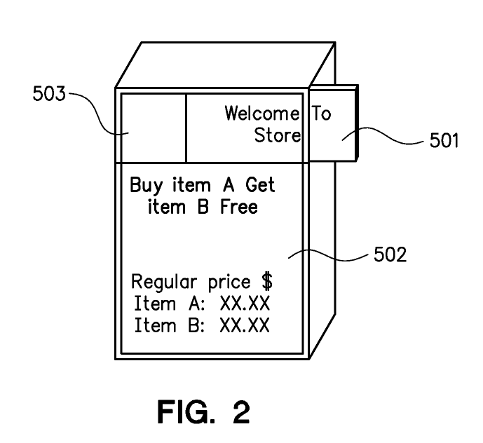

FIG. 1B illustrates main components of the electronic circuitry of an electronic display sign unit such as that of FIG. 1A. A sign controller 202 is coupled to a communication module 201 and to a power manager 206. The sign controller 202 may provide overall control of the electronic display signs. The communication module 201 may provide for wireless communication with one or more servers via one or more networks, for example. Alternatively, the communication module 201 may provide for wired communication, or both wired and wireless communication. Such communication may be used, for example, to control the content of electronic display signs. The power manager 206 conserves battery power by powering down portions of the electronic circuitry insofar as operations allow. The sign controller 202 is coupled to a display driver 203, which is coupled in turn to a display 204.

Whereas FIG. 1A illustrates an exemplary electronic sign with a permanent or infrequently changing message, FIG. 2 illustrates an example of an electronic sign 500 having a holder 503 for inserting a card or placard 501 having a message permanently printed on it. Many enterprises use a common set of secondary messages, for example, “buy one get one free,” “clearance,” “sale,” “door buster offer,” “week end offer,” etc. Such messages may be printed and placed inside the electronic sign 500 in such a way that a store associate can easily select a desired message.

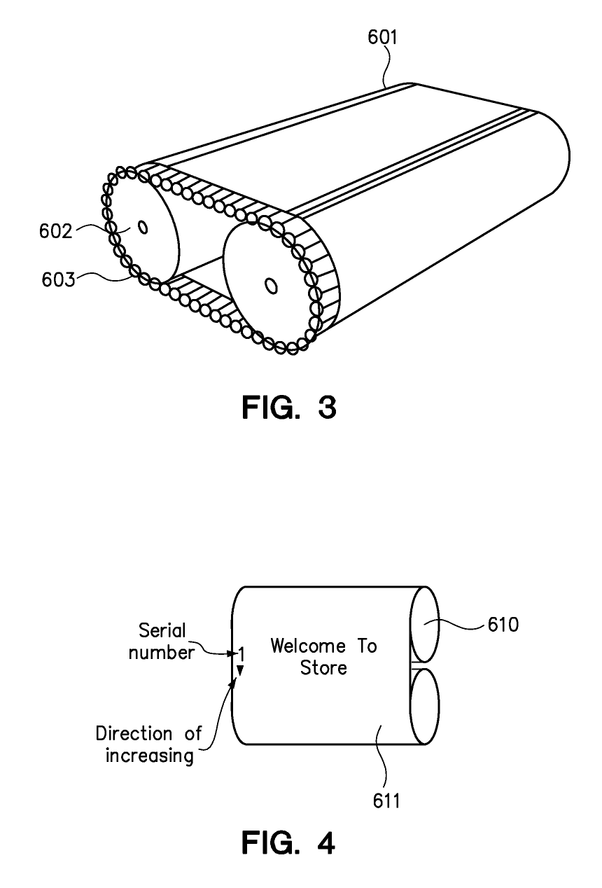

Referring for example to FIG. 3, a changeable secondary set of messages is printed as a roll 601 mounted on a spindle 602. A store associate can easily select a desired message by advancing or reversing the roll 601. In the illustrated embodiment, a band 603 is provided that the user moves using his or her finger tips in order to change the message.

Referring to FIG. 4, a changeable secondary set of messages is printed as a roll 611 mounted on a spindle 610. Assuming there are large numbers of pre-printed messages in a single roll, a serial number 613 and direction indicator 615 may be provided as shown. To display the next sequential message in numbered order, the roll 611 is advanced in the direction of the direction indicator 615. In this manner, the user is enabled to quickly identify the correct direction and find the desired message.

In other embodiments, the electronic sign with changeable message set may be equipped with a low power motor and a low friction arrangement to automate the secondary message selection process. Any of various input devices may be provided to enable a user to advance or reverse the roll or to specify by number a desired message. Alternatively, the motor may be controlled through a network connection, either wired or wireless, to automatically select a desired message.

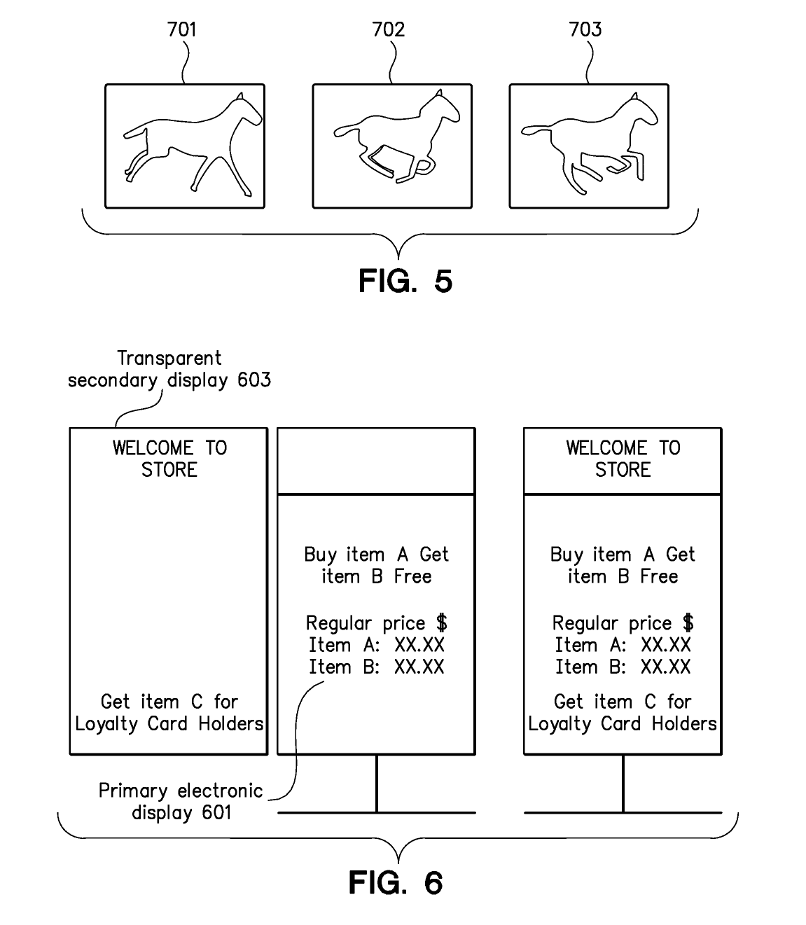

In still further embodiments, the secondary display may be a scanimation display of a known type. In accordance with this technique, multiple images are printed on a substrate in overlapping, encoded fashion. A scanimation filter is provided in moveable arrangement to the image substrate and typically takes the form of a film having alternating black (opaque) and clear (transparent) bars. By slight movement between the scanimation filter and the image substrate, a series of related images are presented to the viewer, producing a visual impression of animation. In FIG. 5, three such images 701, 702 and 703 are shown. The electronic sign may be provided with a low-power, low-friction electric motor to cause relative motion between the scanimation filter and the image substrate. Such motion may be continuous or intermittent and may be manually controlled or network controlled. In this embodiment, as well as the embodiments previously described, the power source may be battery power, wired AC or DC power, photovoltaic, “witricity,” etc.

It will be apparent to those skilled in the part that the present invention can be embodied in different forms without departing from the spirit or essential character thereof. The disclosed embodiments are therefore intended in all respects to be illustrative and not restrictive. The scope of the invention is defined by the appended claims, not the foregoing description, and all changes which come within the range of equivalents thereof are intended to be embraced therein. Words of approximation, except as otherwise noted, are used herein to mean plus or minus twenty percent of nominal value.

What is claimed is:

1. An electronic display sign comprising:
an electronic display; and
a print-based display;
wherein a direction that the electronic display faces and a direction that the print-based display faces are the same.

2. The apparatus of claim 1, wherein the print-based display is configured to allow display content to be varied.

3. The apparatus of claim 1, wherein the electronic display is a monochrome display.

4. The apparatus of claim 1, wherein the electronic display is a bi-stable display.

5. The apparatus of claim 1, wherein the print-based display comprises a placard holder and a placard.

6. The apparatus of claim 1, wherein the placard comprises a transparent material and covers at least a majority of the electronic display.

7. The apparatus of claim 1, wherein the print-based display comprises a roll of different display images.

8. The apparatus of claim 6, comprising a manually-operated member for changing from one image to another image.

9. The apparatus of claim 6, wherein the roll comprises printed image numbers.

10. The apparatus of claim 6, comprising a motor coupled to the roll for changing from one image to another.

11. The apparatus of claim 9, wherein the motor is manually controlled.

12. The apparatus of claim 9, wherein the motor is automatically controlled by the main controller according to the instruction over a network connection.

13. The apparatus of claim 1, wherein the print-based display comprises a scanimation display.

14. The apparatus of claim 13, wherein the scanimation display comprises a motor coupled to the image filter layer for scanning the image filter layer to cause an animation effect.

15. An electronic display sign comprising:
a monochrome electronic display; and
a color display;
wherein a direction that the monochrome electronic display faces and a direction that the color display faces are the same.

16. The apparatus of claim 15, wherein the electronic display is a bi-stable display.

17. The apparatus of claim 15, wherein the color display is a print-based display configured to allow display content to be varied.

18. The apparatus of claim 17, wherein the print-based display comprises a placard holder and a placard.

19. The apparatus of claim 17, wherein the print-based display comprises a roll of different display images.

20. The apparatus of claim 17, wherein the print-based display comprises a scanimation display.
